(19) United States
(12) Patent Application Publication
(10) Pub. No.: US 2013/0164591 A1
(43) Pub. Date: Jun. 27, 2013

(54) PORTABLE ELECTRONIC APPARATUS AND REMOVABLE BATTERY CASE THEREFOR

(71) Applicants: Chia-Cheng Su, New Taipei City (TW); Tsung-Hsien Chen, New Taipei City (TW); Po-Yuan Hsu, New Taipei City (TW); Wei-Cheng Wang, New Taipei City (TW); Hsing-Wang Chang, New Taipei City (TW)

(72) Inventors: Chia-Cheng Su, New Taipei City (TW); Tsung-Hsien Chen, New Taipei City (TW); Po-Yuan Hsu, New Taipei City (TW); Wei-Cheng Wang, New Taipei City (TW); Hsing-Wang Chang, New Taipei City (TW)

(21) Appl. No.: 13/610,836

(22) Filed: Sep. 11, 2012

(30) Foreign Application Priority Data
Dec. 22, 2011 (TW) 100224276

(51) Int. Cl. H01M 2/10

(52) U.S. Cl. 429/100

(57) ABSTRACT

A portable electronic apparatus and a removable battery case therefor are disclosed. The portable electronic apparatus includes an apparatus casing, a battery, and the removable battery case. The apparatus casing has an accommodating slot and includes a first rotation engagement structure at the opening of the accommodating slot. The removable battery case includes a casing body and a casing cover. The casing body has a battery accommodating space containing the battery. The casing cover is connected to the casing body in a rotatable way. When the casing body is inserted into the accommodating slot from the opening, the casing cover covers the opening by a second rotation engagement structure of the casing cover engaged with the first rotation engagement structure. Therefore, the casing body can keep non-rotated in the above insertion to permit various structure designs for the electrical connection between the apparatus casing and the removable battery case.

### BACKGROUND OF THE INVENTION

1. Field of the Invention

The invention relates to a portable electronic apparatus and a removable battery case therefor, and especially relates to a removable battery case of rotational engagement and a portable electronic apparatus having the removable battery case.

2. Description of the Prior Art

Batteries are still the power source for portable electronic apparatuses, mostly in single battery module for operation. Under consideration of operation convenience, the methods for installing the current removable battery module into an accommodating slot of the portable electronic apparatus are described in the following. One is to insert the battery module directly into the accommodating slot and then to close a cover disposed at the opening of the accommodating slot to fix the battery module in the accommodating slot, such as battery module for camera. However, in such structure design, the closing mechanism of the cover is usually based on an engagement structure of single directional sliding. When an external force is loaded on the cover in a reverse direction, it tends to causing instability of the fixing structure of the cover making the cover open and the battery module slipping out possible.

Another method is to structurally integrate the battery module into the portable electronic apparatus, such as battery module for notebook. When the battery module is inserted into the accommodating slot and fixed by at least one latch, the appearance of the battery module matches with that of the portable electronic apparatus. In such structure design, the battery module is hard to fall due to a loading with an external force. However, the exposed portion of the battery module is too much so that the battery module is probably damaged during use. Furthermore, the seam of the engagement between the battery module and the portable electronic apparatus is too long to draw mist, particles and so on in, leading to structural damage on the electrical connection between the battery module and the portable electronic apparatus.

There is another method performed for the battery module made in a single structure. The main portion of the battery module is inserted into the accommodating slot. The cover portion of the battery module is exposed out of the portable electronic apparatus and is capable of being rotation engaged to the portable electronic apparatus. In such structure design, the battery module can be fixed firmly and sealed well. However, the battery module needs to be rotated during the engagement with the portable electronic apparatus, so that the structure design for the electrical connection between the battery module and the portable electronic apparatus is limited. In general, the electrical connection is designed on the basis of elastic contacts. A violent vibration may induce intermittent electrical connection, leading to influence on the operation of the portable electronic apparatus. Therefore, the engagement mechanism for the current removable battery module and the portable electronic apparatus cannot satisfy all the requirements of convenient operation, firm engagement structure, and stable electrical connection.

### SUMMARY OF THE INVENTION

An objective of the invention is to provide a removable battery case, which achieves effect of the casing cover and casing body acting separately by use of a connection mechanism of the casing cover capable of rotating relative to the casing body, so as to solve the problem in the prior art that the conventional engagement mechanism for the removable battery module and the portable electronic apparatus cannot satisfy all the requirements of convenient operation, firm engagement structure, and stable electrical connection.

The removable battery case of the invention is capable of being accommodated in an accommodating slot of an apparatus casing. The accommodating slot has an opening. The apparatus casing includes a first rotation engagement structure at the opening. The removable battery case includes a casing body and a casing cover. The casing body has a first end portion and a second end portion opposite to the first end portion. The casing body has a battery accommodating space for accommodating a battery. The casing cover is connected to the first end portion in a rotatable way and includes a second rotation engagement structure. The second rotation engagement structure is capable of being rotationally engaged with the first rotation engagement structure. When the casing body through the second end portion is inserted into the accommodating slot from the opening, the casing cover is capable of covering the opening by the second rotation engagement structure engaging with the first rotation engagement structure. Thereby, during the insertion, the casing body can be kept not rotated, while the casing cover still can rotate so as to be engaged firmly with the apparatus casing. Furthermore, the invention permits various structure designs for the electrical connection between the apparatus casing and the removable battery case. Therefore, the removable battery case of the invention can satisfy the requirements of convenient operation, firm engagement structure, and stable electrical connection, solving the problem in the prior art.

An objective of the invention is to provide a portable electronic apparatus having the removable battery case of the invention. Similarly, the portable electronic apparatus of the invention can solve the problem in prior art that the conventional engagement mechanism for the removable battery module and the portable electronic apparatus cannot satisfy all the requirements of convenient operation, firm engagement structure, and stable electrical connection.

The portable electronic apparatus of the invention includes an apparatus casing, a removable battery case, and a battery. The apparatus casing has an accommodating slot. The accommodating slot has an opening. The apparatus casing includes a first rotation engagement structure at the opening. The removable battery case includes a casing body and a casing cover. The casing body has a first end portion and a second end portion opposite to the first end portion. The casing body has a battery accommodating space. The battery is accommodated in the battery accommodating space. The casing cover is connected to the first end portion in a rotatable way and includes a second rotation engagement structure. The second rotation engagement structure is capable of being rotationally engaged with the first rotation engagement structure. The casing body through the second end portion is inserted into the accommodating slot from the opening. The casing cover covers the opening by the second rotation engagement structure engaging with the first rotation engagement structure. Similarly, the portable electronic apparatus of the invention uses the design of the casing cover and casing body acting separately to satisfy the requirements of convenient operation, firm engagement structure, and stable electrical connection, solving the problem in the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partially exploded view of a portable electronic apparatus according to a first embodiment according to the invention.

FIG. 2 is a sectional view of a removable battery case of the portable electronic apparatus in FIG. 1 along the line X-X.

FIG. 3 is an exploded view of a casing body and a casing cover of the removable battery case in FIG. 1.

FIG. 4 is an exploded view of an apparatus casing of the portable electronic apparatus in FIG. 1.

FIGS. 5 through 7 are sectional schematic diagrams illustrating the installation of the removable battery case into the apparatus casing in FIG. 1.

FIG. 8 is a side view of a removable battery case of a portable electronic apparatus according to a second embodiment of the invention.

FIG. 9 is a schematic diagram illustrating an apparatus casing of the portable electronic apparatus according to the second embodiment.

### DETAILED DESCRIPTION

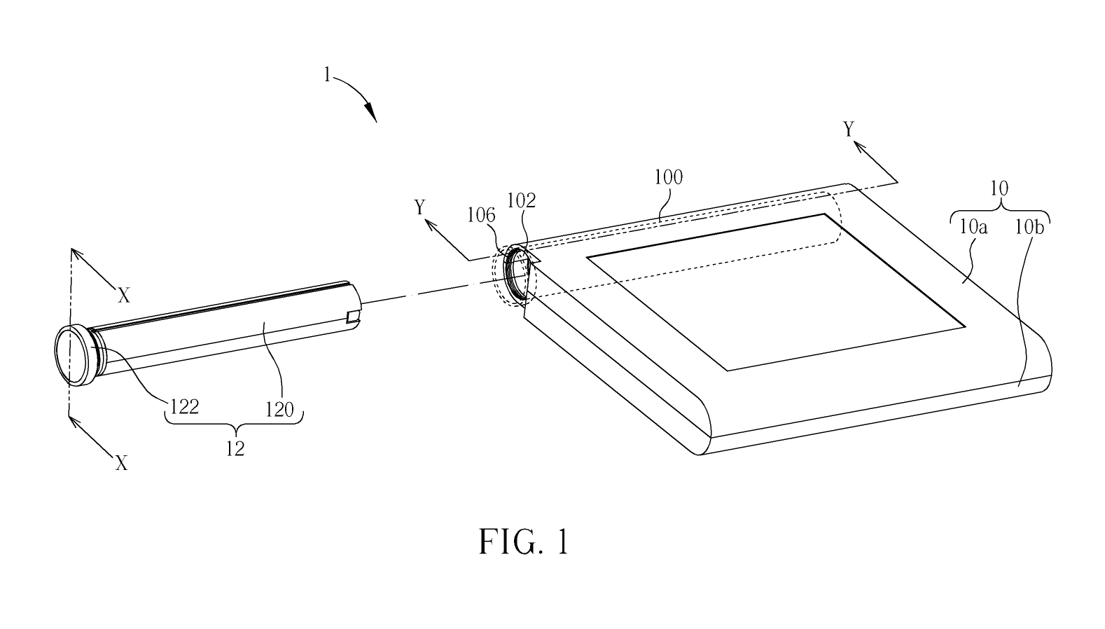

Please refer to FIG. 1, which is a partially exploded view of a portable electronic apparatus 1 according to a first embodiment according to the invention. The portable electronic apparatus 1 includes an apparatus casing 10, a removable battery case 12, and a battery 14. The apparatus casing 10 has an accommodating slot 100 (the position of which is shown by dashed lines in FIG. 1). The accommodating slot 100 has an opening 102. The apparatus casing 10 includes a first rotation engagement structure at the opening 102. In the embodiment, the first rotation engagement structure is a first thread 106. The removable battery case 12 mainly includes a casing body 120 and a casing cover 122. The casing cover 122 is connected to the casing body 120 in a rotatable way, so the casing cover 122 is capable of rotating relative to the casing body 120. The casing cover 122 includes a second rotation engagement structure. In the embodiment, the second rotation engagement structure is a second thread 1230. The second rotation engagement structure is capable of being rotationally engaged with the first rotation engagement structure. The battery 14 is accommodated in the casing body 120 (not shown in FIG. 1). The removable battery case 12 is inserted into the accommodating slot 100 from the opening 102. After the insertion, the casing cover 122 is exposed out of the apparatus casing 10 (shown by dashed lines in FIG. 1). The engagement of the removable battery case 12 with the apparatus casing 10 will be further described later.

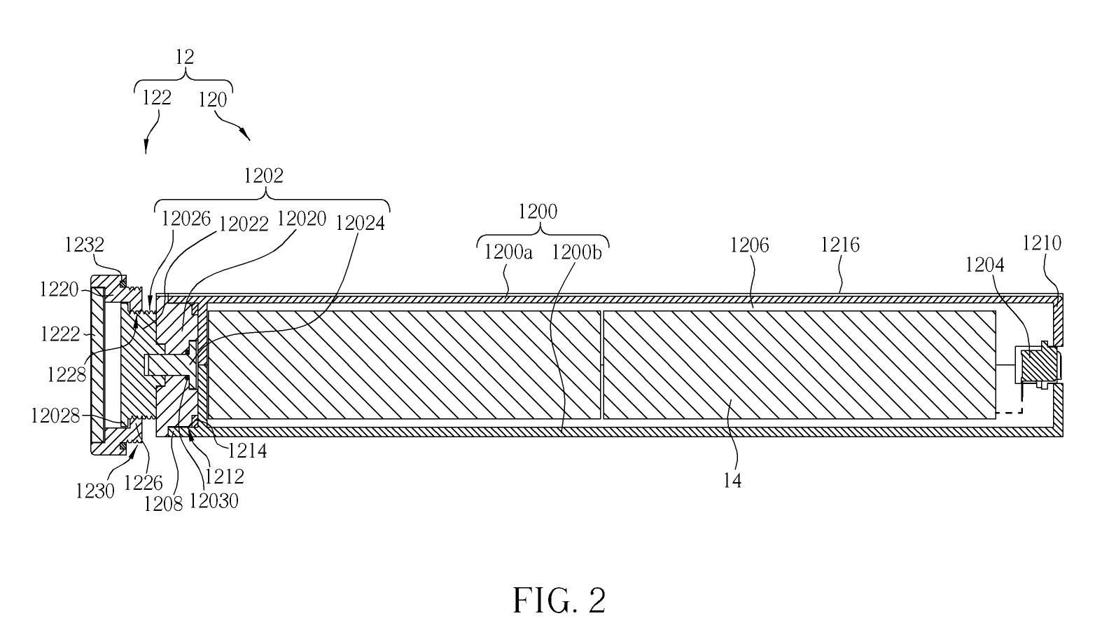

Please refer FIG. 2, which is a sectional view of the removable battery case 12 along the line X-X in FIG. 1. The casing body 120 includes a main part 1200, a connection part 1202, and a clip connector 1204. The main part 1200 is formed mainly by binding an upper casing 1200a and a lower casing 1200b. The main part 1200 forms a battery accommodating space 1206 in central portion thereof. The battery 14 is accommodated in the battery accommodating space 1206. The connection part 1202 is located at a first end portion 1208 of the casing body 120 and includes a fixed part 12020, a threaded part 12022, and a jointing part 12024. The fixed part 12020 is fixed at the first end portion 1208. The jointing part 12024 joints the fixed part 12020 and the threaded part 12022. An outer thread 12026 is formed on the threaded part 12022. The clip connector 1204 is disposed at a second end portion 1210 of the casing body 120 opposite to the first end portion 1208, electrically connected to the battery 14 (indicated by bold dashed lines), and exposed out of the main part 1200.

The casing cover 122 includes a main part 1220 and a cap 1222. The cap 1222 is bound to the main part 1220, for example by gluing or tight fitting. The casing cover 122 includes a recess 1224 and is sleeved on the connection part 1202 by the recess 1224 so as to achieve the effect of the casing cover 122 being capable of rotating relative to the connection part 1202. In the first embodiment, the casing cover 122 includes a first limitation portion 1226 in the recess 1224. The connection part 1202 includes a second limitation portion 12028 at the threaded part 12022. The threaded part 12022 extends into the recess 1224 such that the second limitation portion 12028 can be movably disposed in the recess 1224 and be capable of being retained by the first limitation portion 1226 so as not to escape from the recess 1224. The main part 1220 forms an inner thread 1228 at the opening of the recess 1224 correspondingly to the outer thread 12026. Therefore, the whole casing cover 122 can rotate relative to the casing body 120. Furthermore, because the inner thread 1228 meshes with the outer thread 12026, when the casing cover 122 rotates relative to the casing body 120, the casing cover 122 moves forward in the axial direction of the casing body 120 without ineffective rotation. The casing cover 122 can still rotate relative to the casing body 120 even if the outer thread 12026 and the inner thread 1228 are omitted, which is understood easily by a person having ordinary skill in the art and is not described in detail herein.

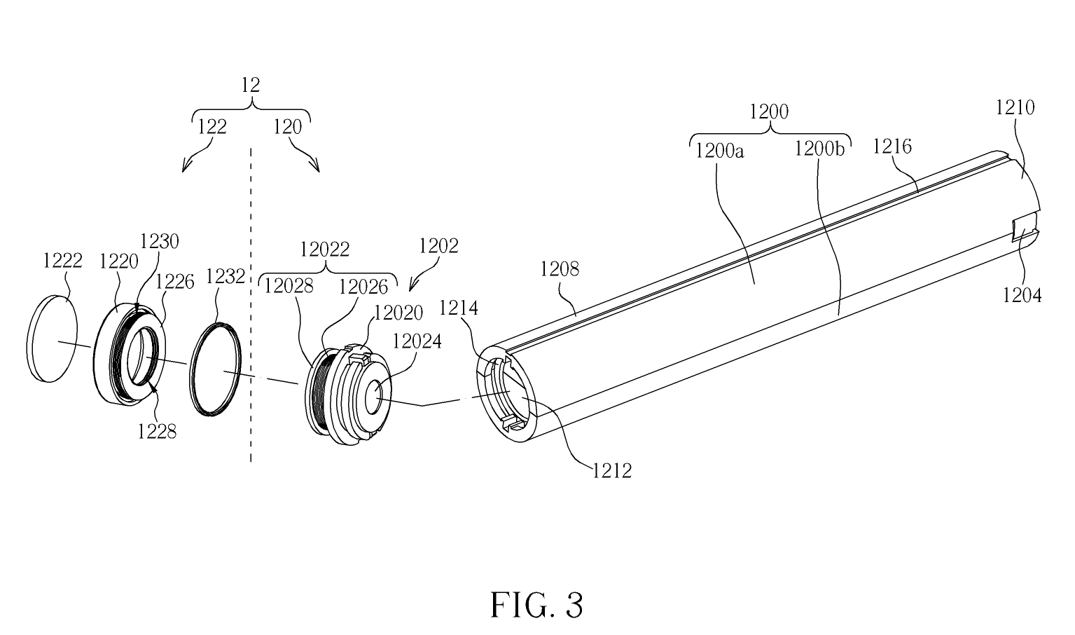

In the first embodiment, the threaded part 12022 and the fixed part 12020 are jointed by the jointing part 12024, such as a screw, but the invention is not limited thereto. For example, the connection part 1202 can be formed in one piece in practice. In addition, in practice, the fixed part 12020 can be fixed on the first end portion 1208 by gluing or tight fitting, but the invention is not limited thereto. In the first embodiment, the fixed part 12020 is fixed on the first end portion 1208 by structural fitting. Please refer to FIG. 2 and FIG. 3. FIG. 3 is an exploded view of the casing body 120 and the casing cover 122. The main part 1200 forms a socket 1212 at the first end portion 1208. A groove structure is formed therein. The fixed part 12020 forms a corresponding groove structure. These groove structures are engaged with each other to achieve the purpose of structural positioning and fixing. The fixed part 12020 will not rotate relative to the main part 1200. It is added that in the first embodiment, the casing body 120 includes an O-ring 1214 disposed inside the socket 1212 between the main part 1200 and the connection part 1202 achieving a waterproof effect. Similarly, in the structure of the connection part 1202, another O-ring 12030 is disposed between the jointing part 12024 and the fixed part 12020, which also achieves a waterproof effect.

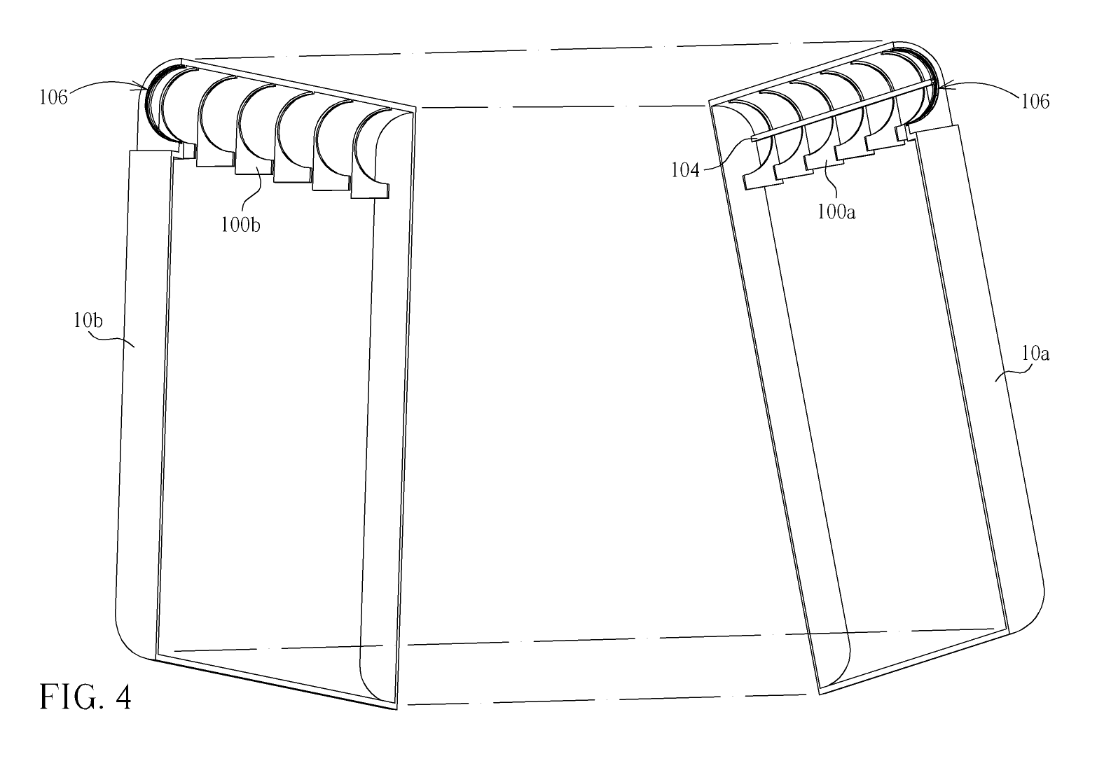

Please refer to FIG. 4, which is an exploded view of the apparatus casing 10. In the first embodiment, the apparatus casing 10 is formed mainly by binding an upper casing 10a and a lower casing 10b. The apparatus casing 10 accommodates other electronic components of the portable electronic apparatus 1. For simple illustration, these electronic components and the structure of the apparatus casing 10 for coordinating with these electronic components are not shown in FIG. 4. As shown in FIG. 4, in the first embodiment, the accommodating slot 100 is formed mainly by a plurality of rib plates 100a and 100b formed on the upper casing 10a and the lower casing 10b respectively. The removable battery case 12 is therefore capable of being accommodated in the constrained space by the rib plates 100a and 100b. The accommodating slot 100 in FIG. 1 is shown by dashed lines, which can be regarded in use as the constrained space. The structure design of the rib plates is conducive to saving material for the apparatus casing 10. However, the invention is not limited thereto. For example, the accommodating slot 100 formed by the rib plates 100a and 100b can be replaced with a tube part.

Please refer to FIG. 3 and FIG. 4. The apparatus casing 10 includes a first orientation structure 104 in the accommodating slot 100. The casing body 120 includes a second orientation structure 1216 on the main part 1200. During the insertion of the casing body 120 through the second end portion 1210 into the accommodating slot 100 from the opening 102 (referring to FIG. 1), the first orientation structure 104 constrains the second orientation structure 1216 to prevent the casing body 120 from rotating relative to the apparatus casing 10. In the first embodiment, the first orientation structure 104 is a long protrusive strip, and the second orientation structure 1216 is a long and narrow groove; however, the invention is not limited thereto. For example, the first orientation structure 104 can be designed to be a long and narrow groove, while the second orientation structure 1216 is designed to be a long protrusive strip or a protrusive block at the second end portion 1210. For another example, the second orientation structure 1216 is still a long and narrow groove, while the first orientation structure 104 can be designed to be a protrusive block near the opening 102 of the accommodating slot 100. In addition, in practice, the disposition quantity of the orientation structure is not limited to one set.

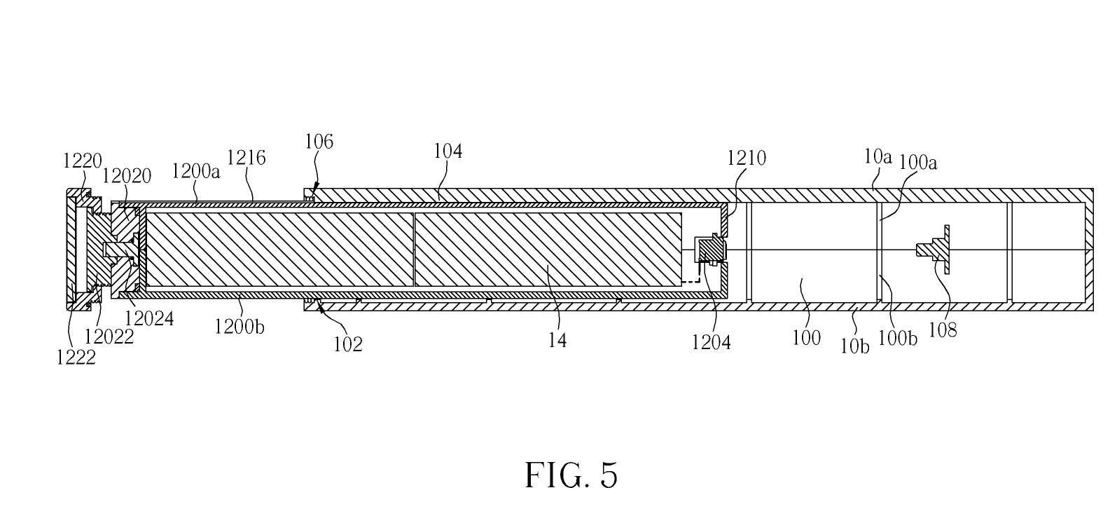

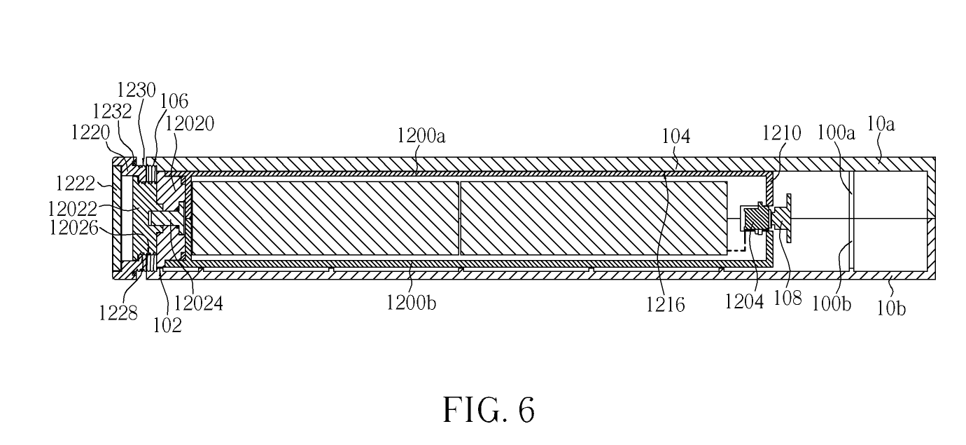

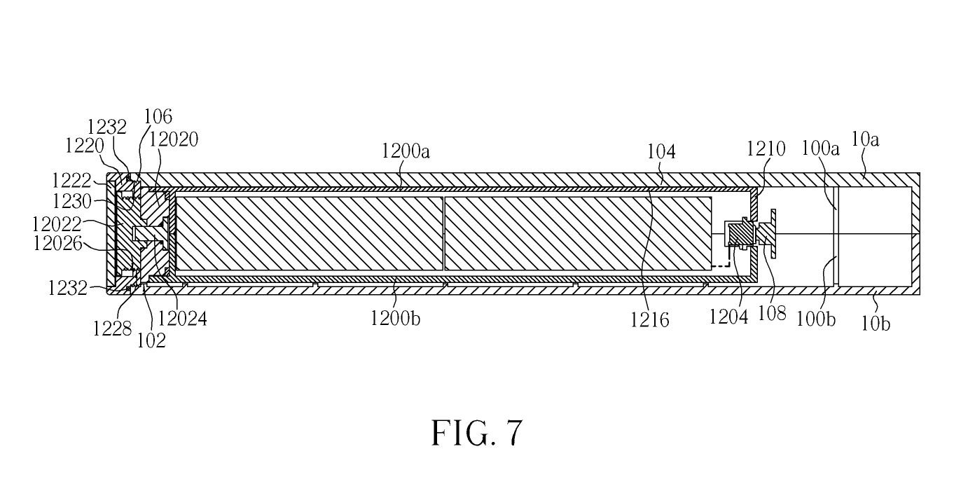

Please FIGS. 5 through 7, which are sectional schematic diagrams illustrating the installation of the removable battery case 12 into the apparatus casing 10. The cutting position therefor is indicated by the line Y-Y in FIG. 1. In the embodiment, the second thread 1230 is matched with the first thread 106 and formed on the main part 1220. During the insertion of the casing body 120 through the second end portion 1210 into the accommodating slot 100 from the opening 102, because the casing body 120 will not rotate relative to the apparatus casing 10 due to the positioning effect by the first orientation structure 104 and the second orientation structure 1216, the clip connector 1204 can be precisely engaged in a detachable way with an electrical connection port 108 of the apparatus casing 10 disposed in the accommodating slot 100, as shown in FIG. 5. Therein, for clear drawing, the electrical connection port 108 is shown only by its position, and the relational disposition structures are skipped. The simplification is also applied to FIG. 6 and FIG. 7. When the casing body 120 is inserted into the accommodating slot 100, the clip connector 1204 is electrically connected with the electrical connection port 108 firmly. Thereby, the battery 14 can power the electronic components insides the apparatus casing 10 through the clip connector 1204 and the electrical connection port 108, and the casing cover 120 can be rotated relative to the casing body 120 (also relative to the apparatus casing 10) so as to be engaged with the apparatus casing 10 and cover the opening 102. As shown in FIG. 6, when the casing cover 122 rotates, because the inner thread 1228 meshes with the outer thread 12026 of the casing body 120, the casing cover 122 moves toward the apparatus casing 10 so that the second thread 1230 of the casing cover 122 can mesh with the first thread 106 of the apparatus casing 10. In other words, during the rotation of the casing cover 122, no ineffective rotation occurs. Therefore, the casing cover 122 can be certainly engaged with the apparatus casing 10. A schematic diagram illustration the removable battery case 12 installed to the apparatus casing 10 is shown by FIG. 7.

Furthermore, the casing cover 122 is engaged with the casing body 120 and the apparatus casing 10 by use of thread structure, which improves the structural strength of jointing the casing body 120 and the apparatus casing 10 and is conducive to the stability of the electrical connection between the clip connector 1204 and the electrical connection port 108. In addition, in the first embodiment, the casing cover 122 includes a seal ring 1232 such as an O-ring. When the casing cover 122 is engaged with the apparatus casing 10, the casing cover 122 uses the seal ring 1232 to seal the seam between the casing cover 122 and the apparatus casing 100, which further improves the dust-proof and waterproof capability of the portable electronic apparatus 1. Furthermore, the accommodating slot 100 is located at a side of the apparatus casing 10; however, the invention is not limited thereto.

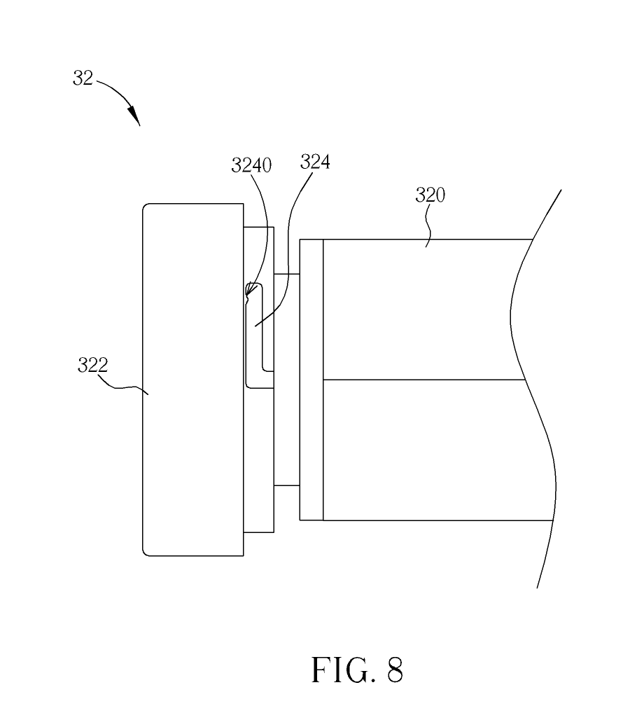

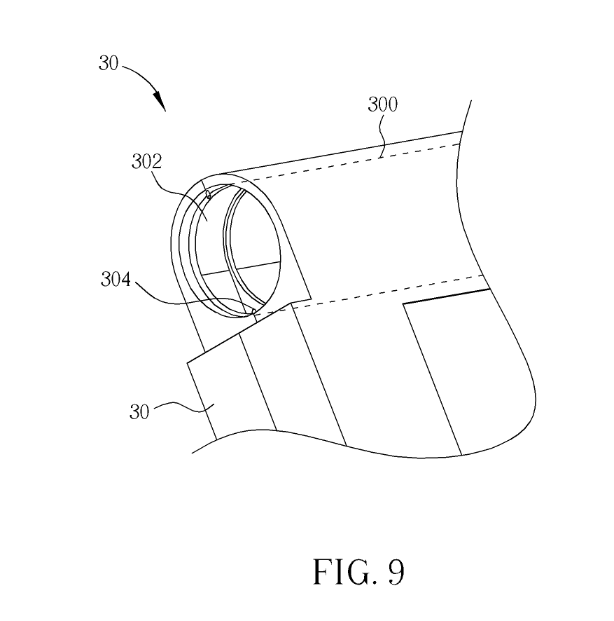

In the first embodiment, the engagement of the casing cover 122 and the apparatus casing is realized by use of thread structure; however, the invention is not limited thereto. Please refer to FIG. 8 and FIG. 9. FIG. 8 is a side view of a removable battery case 32 of a portable electronic apparatus according to a second embodiment of the invention. FIG. 9 is a schematic diagram illustrating an apparatus casing 30 of the portable electronic apparatus according to the second embodiment. The portable electronic apparatus according to the second embodiment and the portable electronic apparatus 1 according to the first embodiment are similar in structure. The main difference therebetween is that the first rotation engagement structure of the apparatus casing 30 at the opening 302 of the accommodating slot 300 (the position of which is shown by dashed lines in FIG. 9) is a post 304, and the corresponding second rotation engagement structure of the casing cover 322 of the removable battery case 32 is an L-shaped guiding slot 324. The casing cover 322 can be engaged with the apparatus casing 30 by rotationally engaging the post 304 with the L-shaped guiding slot 324. In the second embodiment, the L-shaped guiding slot 324 has a positioning protrusion 3240, so that the post 304 can be held by the positioning protrusion 3240 when the post 304 moves to the end portion of the L-shaped guiding slot 324. It is added that in practice, the first rotation engagement structure can be an L-shaped guiding slot while the second rotation engagement structure is a post.

In the above embodiments, the casing bodies 120 and 320 are cylindrical; however, the invention is not limited thereto. In the removable battery case of the invention, the casing cover can rotate relative to the casing body, and the profile of the casing body does not constrain the rotation of the casing cover no longer, so the profile of the casing body can be determined by product design, for example designing the cross section of the casing body to be a non-circular figure, such as rectangle, ellipse and so on. The cross section of the accommodating slot of the apparatus casing can also be designed to be a rectangle, ellipse or other non-circular figures accordingly. In this case, the casing body not only can accommodate a required battery but also can provide orientation function during insertion.

As discussed above, the invention achieves effect of the casing cover and casing body acting separately by use of a connection mechanism of the casing cover capable of rotating relative to the casing body, so that the insertion of the casing body is free from the engagement of the casing with the apparatus casing. In other words, the insertion of the casing body can be designed in coordination with requirement for the engagement of the connectors of the casing body and the apparatus casing without influence on the engagement of the casing cover and the apparatus casing. The engagement mechanism of the casing cover and the apparatus casing therefore can be designed independently by product specification or use habit. Therefore, the invention can solve the problem in the prior art that the conventional engagement mechanism for the removable battery module and the portable electronic apparatus cannot satisfy all the requirements of convenient operation, firm engagement structure, and stable electrical connection.

Those skilled in the art will readily observe that numerous modifications and alterations of the device and method may be made while retaining the teachings of the invention. Accordingly, the above disclosure should be construed as limited only by the metes and bounds of the appended claims.

1. A removable battery case capable of being accommodated in an accommodating slot of an apparatus casing, the accommodating slot having an opening, the apparatus casing comprising a first rotation engagement structure at the opening, the removable battery case comprising:
a casing body having a first end portion and a second end portion opposite to the first end portion, the casing body having a battery accommodating space; and
a casing cover connected to the first end portion in a rotatable way and comprising a second rotation engagement structure, the second rotation engagement structure being capable of being rotationally engaged with the first rotation engagement structure, wherein when the casing body through the second end portion is inserted into the accommodating slot from the opening, the casing cover is capable of covering the opening by the second rotation engagement structure engaging with the first rotation engagement structure.

2. The removable battery case of claim 1, wherein the casing body comprises a connection part at the first end portion, and the casing cover is sleeved on the connection part and is rotatable relative to the connection part.

3. The removable battery case of claim 2, wherein the connection part has an outer thread, the casing cover has an inner thread, and the inner thread meshes with the outer thread.

4. The removable battery case of claim 3, wherein the connection part comprises a fixed part, a threaded part, and a jointing part, the fixed part is mounted on the first end portion, the jointing part joints the fixed part and the threaded part, and the outer thread is formed on the threaded part.

5. The removable battery case of claim 2, wherein the casing cover comprises a recess and a first limitation portion in the recess, and the connection part comprises a second limitation portion movably disposed in the recess and capable of being retained by the first limitation portion so as not to escape from the recess.

6. The removable battery case of claim 1, the first rotation engagement structure being a first thread, wherein the second rotation engagement structure is a second thread, and the second thread matches the first thread.

7. The removable battery case of claim 1, wherein the first rotation engagement structure is a first guiding post or a first L-shaped guiding slot, and the second rotation engagement structure is a second L-shaped guiding slot or a second guiding post correspondingly.

8. The removable battery case of claim 1, the apparatus casing comprising a first orientation structure in the accommodating slot, wherein the casing body comprises a second orientation structure, and the first orientation structure constrains the second orientation structure to prevent the casing body from rotating relative to the apparatus casing during insertion of the casing body through the second end portion into the accommodating slot from the opening.

9. The removable battery case of claim 1, wherein the casing body comprises a clip connector at the second end portion, the apparatus casing comprises an electrical connection port in the accommodating slot, and when the casing body through the second end portion is inserted into the accommodating slot from the opening, the clip connector is electrically connected with the electrical connection port.

10. The removable battery case of claim 1, wherein the casing cover comprises a seal ring, and when the second rotation engagement structure and the first rotation engagement structure are engaged, the seal ring seals seam between the casing cover and the apparatus casing.

11. The removable battery case of claim 1, wherein the casing body is cylindrical substantially.

12. A portable electronic apparatus, comprising:
an apparatus casing having an accommodating slot, the accommodating slot having an opening, the apparatus casing comprising a first rotation engagement structure at the opening;
a removable battery case, comprising:
a casing body having a first end portion and a second end portion opposite to the first end portion, the casing body having a battery accommodating space; and
a casing cover connected to the first end portion in a rotatable way and comprising a second rotation engagement structure, the second rotation engagement structure being capable of being rotationally engaged with the first rotation engagement structure, wherein the casing body through the second end portion is inserted into the accommodating slot from the opening, and the casing cover covers the opening by the second rotation engagement structure engaging with the first rotation engagement structure; and
a battery accommodated in the battery accommodating space.

13. The portable electronic apparatus of claim 12, wherein the casing body comprises a connection part at the first end portion, and the casing cover is sleeved on the connection part and is rotatable relative to the connection part.

14. The portable electronic apparatus of claim 13, wherein the connection part comprises a fixed part, a threaded part, and a jointing part, the fixed part is mounted on the first end portion, the jointing part joints the fixed part and the threaded part, the threaded part has an outer thread, and the casing cover has an inner thread meshing with the outer thread.

15. The portable electronic apparatus of claim 13, wherein the casing cover comprises a recess and a first limitation portion in the recess, and the connection part comprises a second limitation portion movably disposed in the recess and capable of being retained by the first limitation portion so as not to escape from the recess.

16. The portable electronic apparatus of claim 12, wherein the first rotation engagement structure is a first thread, the second rotation engagement structure is a second thread, and the second thread matches the first thread.

17. The portable electronic apparatus of claim 12, wherein the first rotation engagement structure is a first guiding post or a first L-shaped guiding slot, and the second rotation engagement structure is a second L-shaped guiding slot or a second guiding post correspondingly.

18. The portable electronic apparatus of claim 12, wherein the apparatus casing comprises a first orientation structure in the accommodating slot, the casing body comprises a second orientation structure, and the first orientation structure constrains the second orientation structure to prevent the casing body from rotating relative to the apparatus casing during insertion of the casing body through the second end portion into the accommodating slot from the opening.

19. The portable electronic apparatus of claim 12, wherein the apparatus casing comprises an electrical connection port in the accommodating slot, the casing body comprises a clip connector at the second end portion and electrically connected to the battery, and the clip connector is electrically connected with the electrical connection port in a detachable way.

20. The portable electronic apparatus of claim 12, wherein the accommodating slot is disposed at a side of the apparatus casing.
